(19) United States
(12) Patent Application Publication
(10) Pub. No.: US 2016/0146936 A1
(43) Pub. Date: May 26, 2016

(54) Sonar Data Collection

(71) Applicant: Navico Holding AS, Egersund (NO)

(72) Inventor: Gregory Konig, Tulsa, OK (US)

(21) Appl. No.: 14/555,032

(22) Filed: Nov. 26, 2014

(51) Int. Cl. G01S 15/96; G01S 7/56

(52) U.S. Cl. CPC G01S 15/96; G01S 7/56

(57) ABSTRACT

Various implementations described herein are directed to a non-transitory computer readable medium having stored thereon computer-executable instructions which, when executed by a computer, may cause the computer to receive sonar data recorded by a sonar device on a marine vessel. The sonar data is recorded during a plurality of fishing trips. The computer may analyze the sonar data to detect sonar data corresponding to one or more fish. The computer may receive locations corresponding to the fish. The computer may also use the locations to display the detected fish on a map.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Fishermen may use sonar directed at the bottom of a body of water to determine whether there are fish in the water, and the depths of the fish. A machine that implements this sonar is often referred to as a fish finder or sounder. A sonar device may be active throughout a fishing trip, in order to constantly monitor the presence of fish beneath a boat, the depth of the water, or any other objects present in the water. The sonar data may also be used to determine other information, such as the hardness or softness of the seabed. This information may be useful to a fisherman.

### SUMMARY

Described herein are implementations of various technologies for displaying detected fish on a map. In one implementation, a non-transitory computer-readable medium having stored thereon computer-executable instructions which, when executed by a computer, cause the computer to perform various actions. The actions may include receiving sonar data recorded by a sonar device on a marine vessel. The sonar data is recorded during a plurality of fishing trips. The actions may include analyzing the sonar data to detect sonar data corresponding to one or more fish. The actions may include receiving locations corresponding to the fish. The actions may also include using the locations to display the detected fish on a map.

Described herein are also implementations of various technologies for displaying retrieved sonar data on a map. In one implementation, a non-transitory computer-readable medium having stored thereon computer-executable instructions which, when executed by a computer, cause the computer to perform various actions. The actions may include receiving a location, a date, a time, environmental conditions, or combinations thereof. The actions may include retrieving sonar data recorded during a plurality of fishing trips corresponding to the location, date, time, environmental conditions, or combinations thereof. The actions may also include displaying the retrieved sonar data on a map.

Described herein are also implementations of various technologies for determining suggested fishing locations. In one implementation, a non-transitory computer-readable medium having stored thereon computer-executable instructions which, when executed by a computer, cause the computer to perform various actions. The actions may include receiving a location, a date, a time, environmental conditions, or combinations thereof. The actions may include retrieving sonar data recorded using a sonar device on a marine vessel corresponding to the location, date, time, environmental conditions, or combinations thereof. The actions may also include analyzing the retrieved sonar data to determine one or more suggested fishing locations.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a sonar display in accordance with implementations of various techniques described herein.

FIG. 2 is a flow diagram for a method of aggregating sonar data in accordance with implementations of various techniques described herein.

FIG. 3 is a flow diagram for a method of displaying historical sonar data in accordance with implementations of various techniques described herein.

FIG. 4 is a flow diagram for a method of displaying fishing suggestion in accordance with implementations of various techniques described herein.

FIG. 5A illustrates a fishing suggestion display in accordance with various implementations described herein.

FIG. 5B illustrates a fishing suggestion display with selections in accordance with various implementations described herein.

FIG. 6 is a diagram of fishing data sources in accordance with implementations of various techniques described herein.

FIG. 7 illustrates a schematic diagram of a computing system in which the various technologies described herein may be incorporated and practiced.

FIG. 8 illustrates a schematic of a marine electronics device in accordance with implementations of various techniques described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

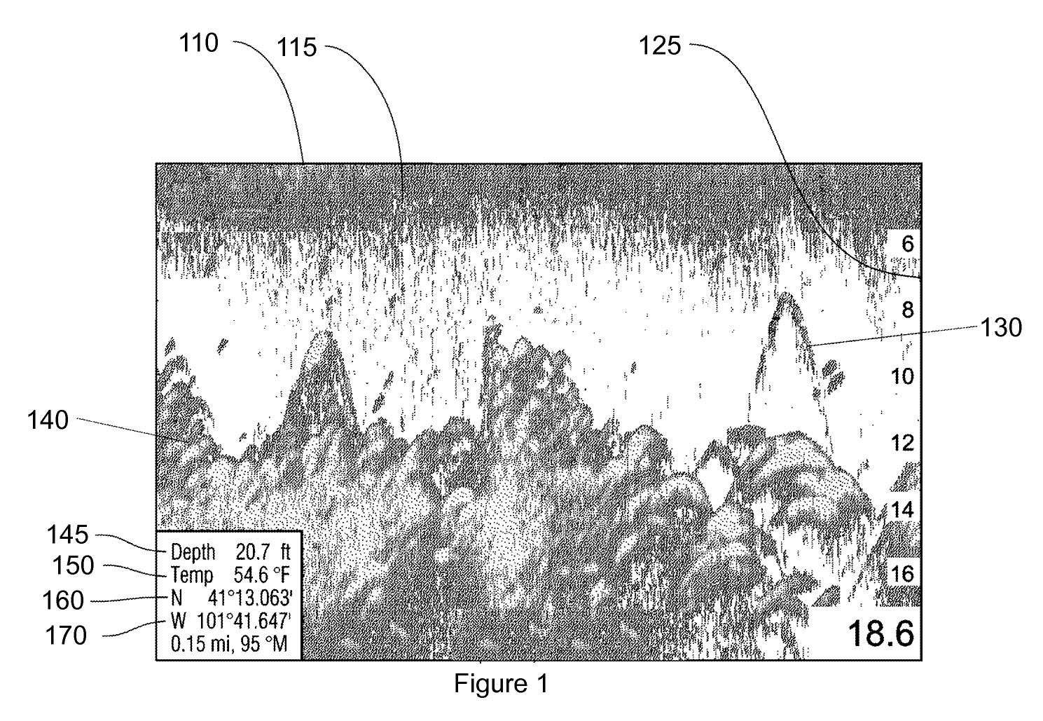

Various implementations of sonar data collection described herein will now be described in more detail with reference to FIGS. 1-8.

FIG. 1 illustrates a sonar display 110 in accordance with implementations of various techniques described herein. The sonar display 110 may illustrate sonar data 115 received using a sonar device. The sonar data 115 may correspond to the underlying body of water in the vicinity of the sonar device. The sonar device may be a fishfinder or a sounder. The sonar data 115 may be viewed to determine the depth of the water, any objects or formations in the water, or the presence of any fish in the water. The sonar data 115 may include reflections corresponding to one or more fish. The reflections corresponding to the one or more fish may be in an arc shape. The sonar data 115 may also include information corresponding to the biomass present in the water. For example, sonar data 115 may be used to estimate the amount of marine life in a body of water. The sonar data 115 may include reflections in a conical formation, i.e., the reflections may correspond to a greater area as depth increases.

The sonar display 110 is a two-dimensional graphic, where the vertical axis represents depth and the horizontal axis represents time. The newest sonar data 115 may be displayed to the right, and older sonar data 115 may be displayed to the left. As new sonar data 115 is received, the previously recorded sonar data 115 may travel from right to left.

The sonar display 110 may illustrate the bottom of a body of water (e.g., seabed or lake bottom) 140, and any objects located on the bottom of the body of water. The sonar display 110 may also illustrate one or more fish, which may be recorded as arcs 130 in the sonar data 115. In one implementation, the arcs may be automatically interpreted as fish, and the arcs may be replaced by fish symbols in the sonar display 110. The automatic detection and interpretation of arcs as fish is referred to as a Fish identification (ID). The Fish IDs may be recorded along with their corresponding depths, GPS locations, time, date, water temperatures, weather data, or any other relevant information.

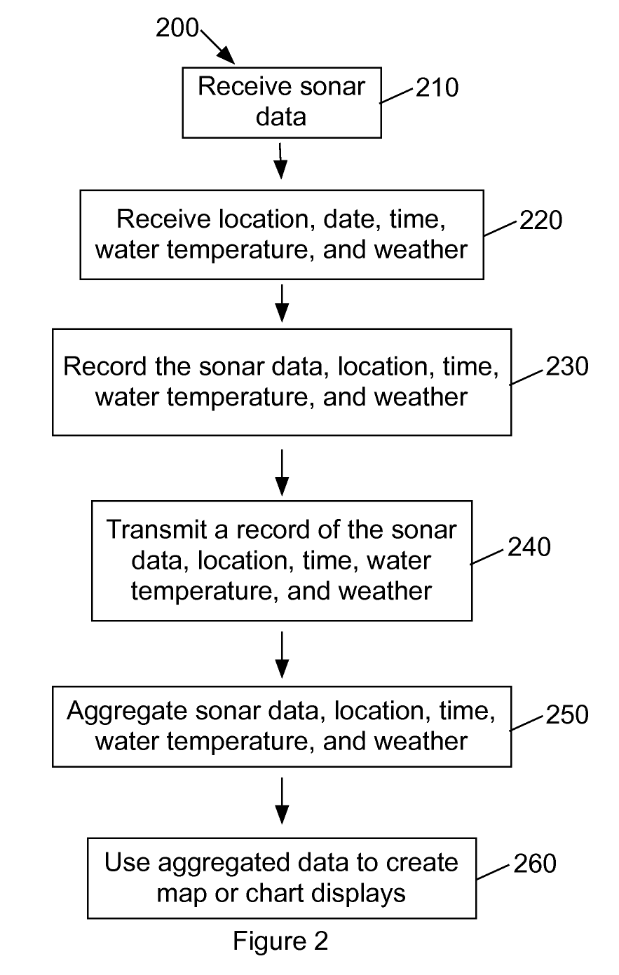

FIG. 2 is a flow diagram for a method 200 of aggregating sonar data in accordance with implementations of various techniques described herein. In one implementation, method 200 may be performed by any computer system 700, including a portable computer system, a smart phone device, a remote server, a marine electronics device 800, a cloud server and the like. It should be understood that while method 200 indicates a particular order of execution of operations, in some implementations, certain portions of the operations might be executed in a different order, and on different systems. Further, in some implementations, additional operations or steps may be added to the method 200. Likewise, some operations or steps may be omitted.

At block 210, the method 200 may receive sonar data. An example of sonar data is illustrated in FIG. 1. In one implementation, the method 200 may apply a filter to remove false positives from the sonar data. The false positives may be sonar data that resembles a fish but is not actually a fish. For example, a false positive may be debris or bubbles in the water. In order to determine whether the sonar data is a fish or a false positive, the algorithm may examine previously recorded sonar data from the same location, or sonar data from other locations.

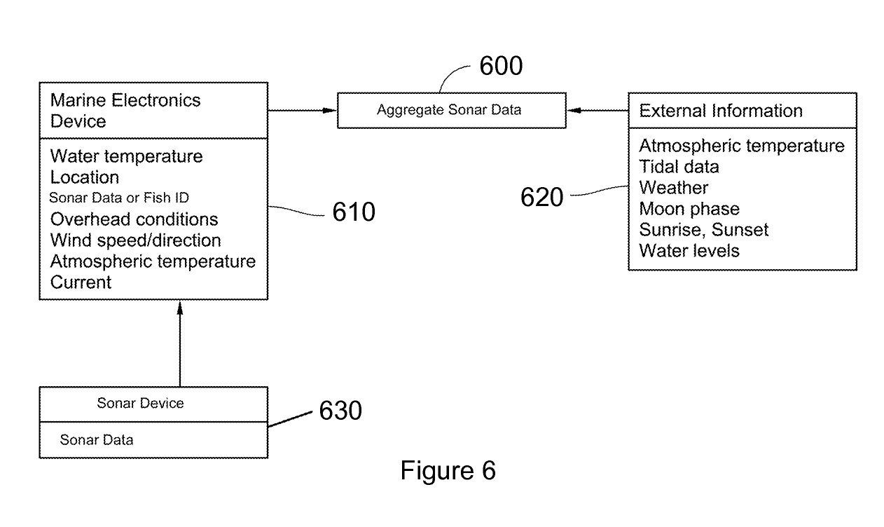

At block 220, the method 200 may receive data indicating a location, heading, date, time, water temperature, environmental conditions, or other information corresponding to the sonar data received at block 210. The environmental conditions may include water temperature, air temperature, current, wind speed and direction, precipitation, light levels, cloud cover, or other weather or environmental data. FIG. 6, described below, illustrates an example of various data sources that may be used to collect information corresponding to the sonar data.

At block 230, a record describing the sonar data received at block 210 and corresponding information received at block 220 may be stored. For example, the record may be stored in a database. In one implementation, sonar data may be recorded throughout a fishing trip and stored with a corresponding location, heading, date, time, environmental conditions, or other related information.

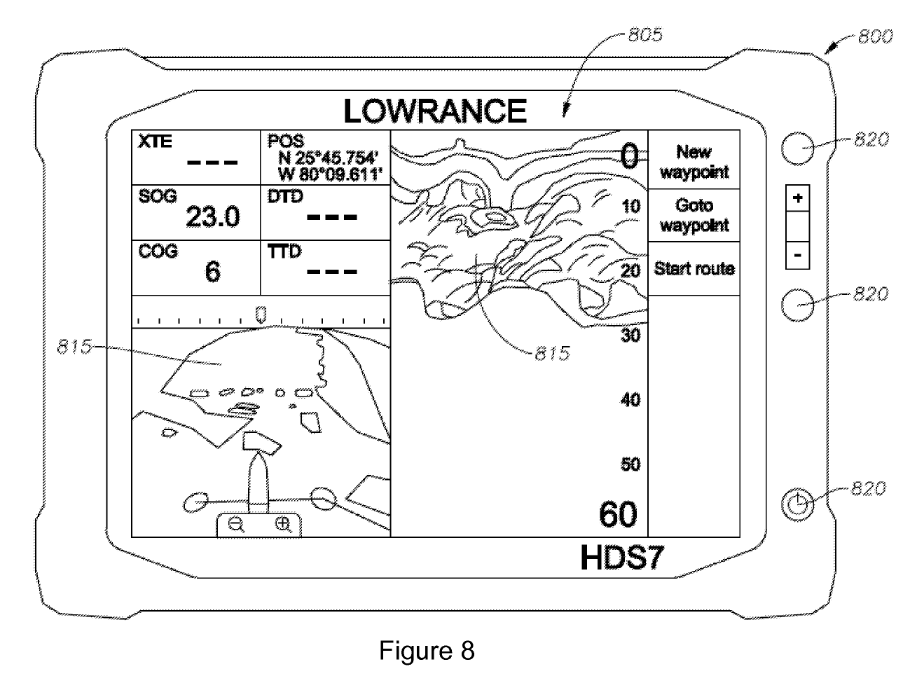

At block 240, the data stored at block 230 may be transmitted. For example, the data may be stored throughout a fishing trip on a marine electronics device 800, described below and in FIG. 8. In this example, after the fishing trip is complete, the marine electronics device 800 may transmit the data to a cloud software service. In another example, the marine electronics device 800 may transmit the data to the cloud software service during the trip in substantially real time.

Once transmitted, at block 250, the method 200 may aggregate the sonar data. For example, the sonar data may be aggregated based on location. In one implementation, the data transmitted at block 240 may be data collected during one or more fishing trips by a single fisherman, and the data may then be aggregated at block 250 with data collected during previous fishing trips by the fisherman. In a second implementation, the data may be aggregated with data collected by other fishermen for the same location.

Aggregating the data may reduce the amount of storage necessary to store the sonar and related data. Aggregating the sonar data may also make retrievals of the data more efficient. For example, if the sonar data is aggregated by location, a retrieval based on location may be more efficient than the same retrieval for data that is not aggregated by location.

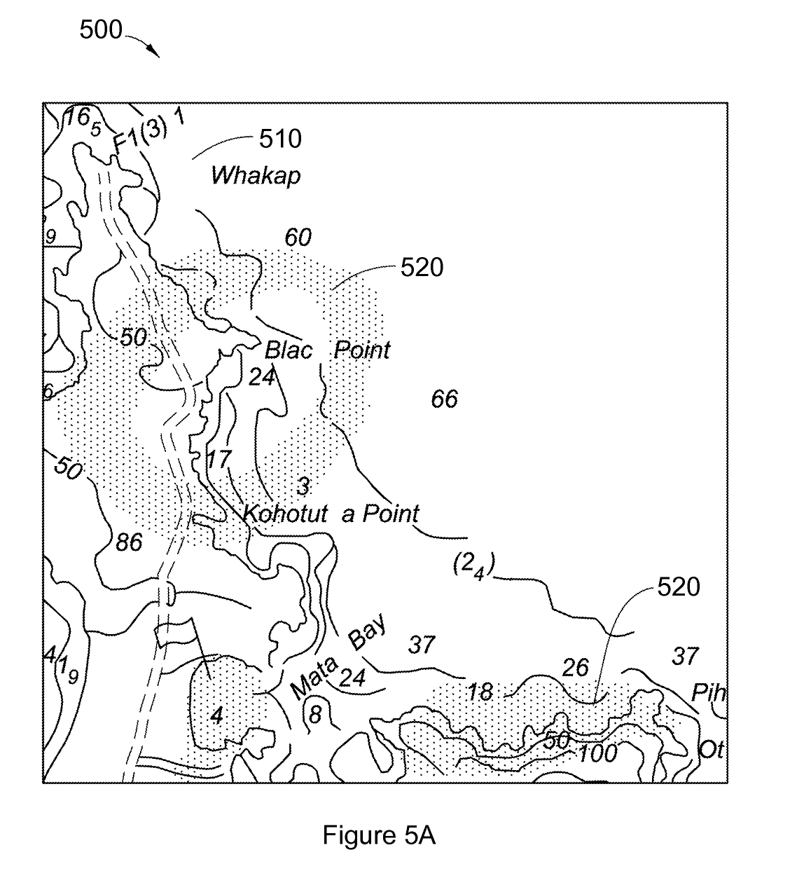

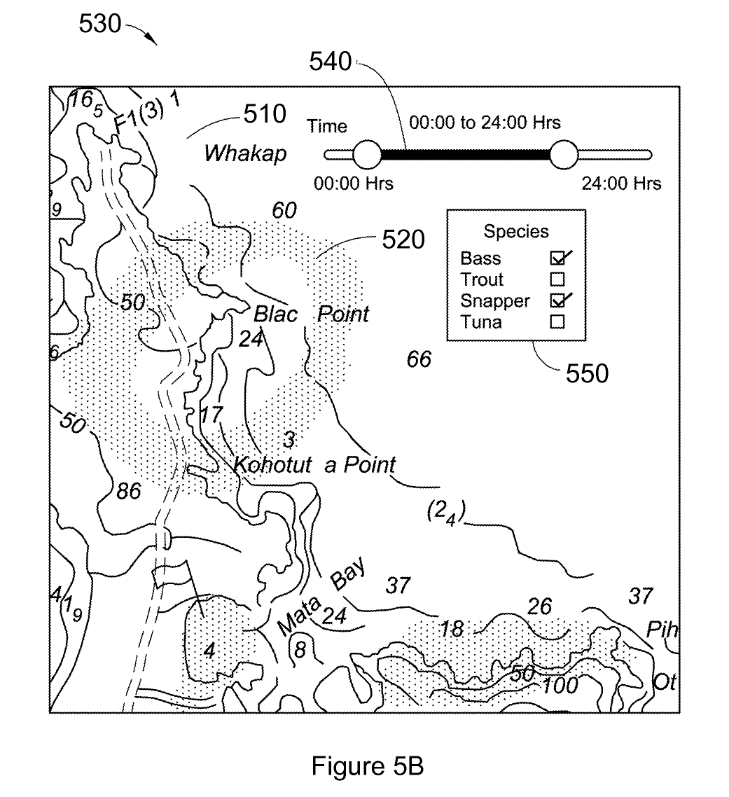

At block 260, the data aggregated at block 250 may be used to create map or chart displays of aggregated sonar data. FIGS. 5A and 5B illustrate examples of map displays that may be generated using aggregated sonar data. The maps may indicate areas with a relatively high amount of sonar activity. For example, areas where the sonar data frequently indicates that objects are in the water may be indicated using a color or pattern on a map. A map created at block 260 may indicate locations with a strong sonar signal return. For example, the map may indicate locations with a sonar signal return greater than a set sonar signal return level. In one implementation, the map display may display information collected during a single fishing trip. In another implementation, the map display may display information collected by one fisherman during multiple fishing trips. In yet another implementation, the map display may display information collected by multiple fishermen.

Method 200 may be used to collect and review sonar data in real time during a fishing trip. In one implementation, sonar data may be collected during a fishing trip and aggregated and displayed on a marine electronics device 800. In this implementation, block 240 may be skipped. In this implementation, displays similar to the displays illustrated in FIGS. 5A and 5B may be generated and displayed in real time on a marine electronics device 800.

In one implementation, method 200 may receive and aggregate Fish IDs as an alternative to sonar data. In this implementation, a marine electronics device 800 or other computer system 700 may examine sonar data to detect individual fish. The marine electronics device 800 may then record the depth of the fish, location of the fish, and other data at block 230. For example, the sonar signal return strength may be analyzed to determine a size or weight of a detected fish, and the size or weight may then be recorded. At block 240, method 200 may transmit the record of the Fish ID and other data to a cloud software service. At block 250, the Fish IDs and associated data may be aggregated with other Fish IDs for storage. At block 260, the Fish IDs may be displayed on a chart or map. For example, individual Fish IDs may be displayed on a map as points or icons. In another example, a map may indicate areas with a higher concentration of Fish IDs.

In another implementation, method 200 may analyze sonar data to detect structures. For example, the sonar data may be analyzed to detect structures holding fish. The structures may then be displayed on a chart or map.

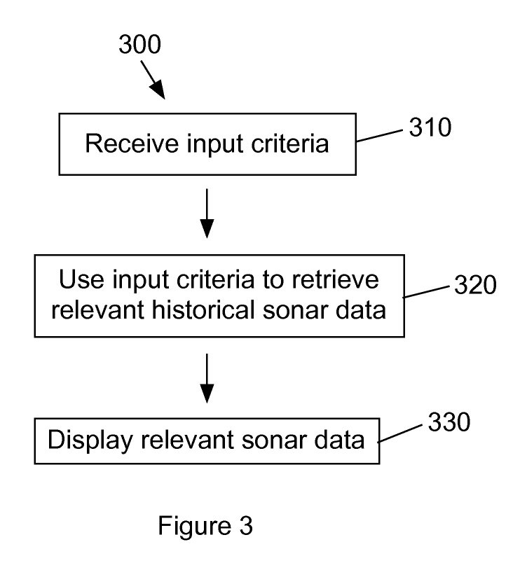

FIG. 3 is a flow diagram for a method of displaying historical sonar data in accordance with implementations of various techniques described herein. In one implementation, method 300 may be performed by any computer system 700, including a portable computer system, a smart phone device, a remote server, a marine electronics device 800, a cloud server and the like. It should be understood that while method 300 indicates a particular order of execution of operations, in some implementations, certain portions of the operations might be executed in a different order, and on different systems. Further, in some implementations, additional operations or steps may be added to the method 300. Likewise, some operations or steps may be omitted.

At block 310, method 300 may receive input criteria. The input criteria may include a location, date, tide, wind direction and strength, water temperature, or species. Other input criteria may be used as well. The input criteria may be input by a user. Input criteria may also be automatically determined. For example, if a time and date is entered, the tidal information may be automatically determined. In another example, when a fisherman is on the water, measurements, including temperature and location, may be recorded by a marine electronics device 800 and used as input criteria.

At block 320, method 300 may use the input criteria to retrieve relevant historical sonar data. The historical sonar data may be aggregated sonar data, including sonar data aggregated using methods 200 The historical sonar data may include Fish IDs. The historical sonar data may be data recorded by one or more users. The historical sonar data may include the location, time, environmental information, and other information related to the sonar data. The historical sonar data may be stored, maintained, and retrieved by a cloud software service. Examples of data sources for the sonar data are explained in FIG. 6. Relevant historical sonar data may be sonar data recorded under the same or similar conditions as the input criteria.

For example, if the input criteria received at block 310 includes a location that is a lake, at block 320 all recorded sonar data or Fish IDs that were recorded on the lake may be retrieved. In another example, if the input criteria received at block 310 includes a tide and season, then method 300 may retrieve all sonar data or Fish IDs that were recorded during the selected season and when tidal conditions were similar to the selection.

At block 330, the method 300 may display the sonar data retrieved at block 320. The display may be generated at block 330 in response to receiving a user request to generate a display. Examples of displays that may be generated are illustrated in FIGS. 5A and 5B.

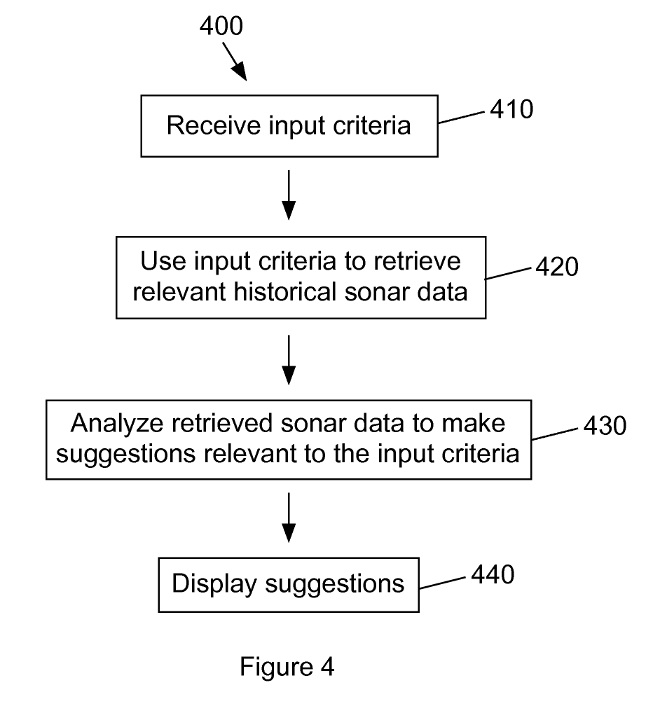

FIG. 4 is a flow diagram for a method of displaying fishing suggestion in accordance with implementations of various techniques described herein. In one implementation, method 400 may be performed by any computer system 700, including a portable computer system, a smart phone device, a remote server, a marine electronics device 800, a cloud server and the like. It should be understood that while method 400 indicates a particular order of execution of operations, in some implementations, certain portions of the operations might be executed in a different order, and on different systems. Further, in some implementations, additional operations or steps may be added to the method 400. Likewise, some operations or steps may be omitted.

At block 410, method 400 may receive input criteria. Other actions similar to those performed at block 310 may be performed at block 410.

At block 420, method 400 may use the input criteria received at block 410 to retrieve relevant historical sonar data. Other actions similar to those performed at block 320 may be performed at block 420.

At block 430, method 400 may analyze the data retrieved at block 420 in order to make suggestions relevant to the input criteria received at block 410. In one implementation, at block 430, the individual Fish IDs or sonar data points retrieved at block 420 may be weighted based on the input criteria, and then combined to form suggestions. For example, if a Fish ID is recorded within the selected location when conditions were similar to the input criteria, then that Fish ID would be weighted heavily, whereas if a Fish ID is recorded when conditions were not similar to the input criteria, the Fish ID would not be weighted heavily.

In another implementation, where Fish IDs or sonar data are retrieved at block 420, method 400 may determine areas with a greater than average concentration of Fish IDs, or areas with a greater than average amount of sonar activity. For example, an area with a high concentration of Fish IDs in conditions similar to the input criteria may be suggested as a good area to fish.

In yet another implementation, the Fish IDs or sonar data may be examined for patterns. For example, if there is a greater amount of sonar activity or Fish IDs in certain conditions, method 400 may suggest fishing in those conditions.

At block 440, method 400 may display the suggestions. Other actions similar to those performed at block 330 may be performed at block 440.

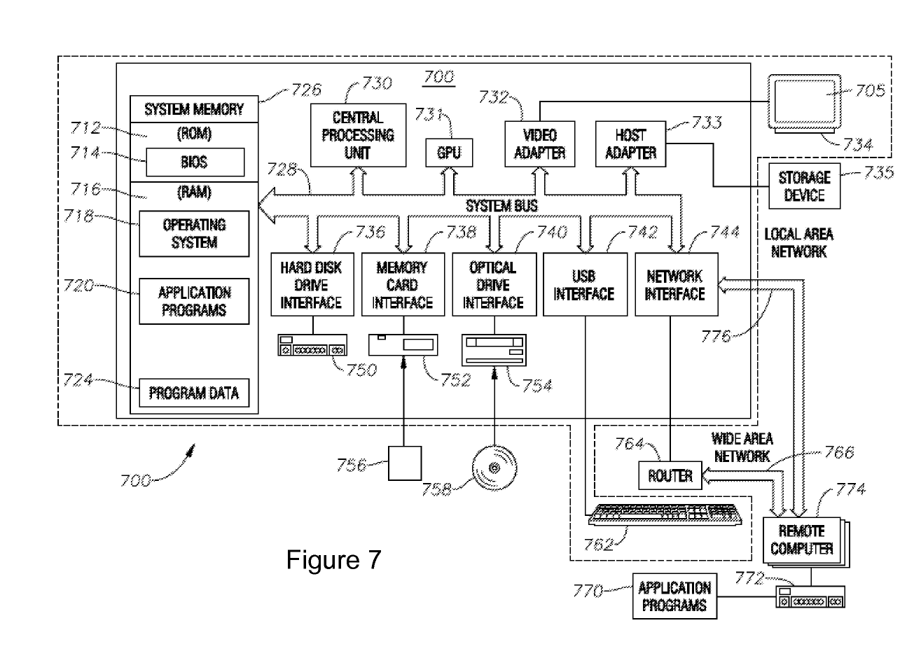

FIG. 5A illustrates a fishing suggestion display in accordance with various implementations described herein. The fishing suggestion display 500 may be displayed on a marine electronics device as described in FIG. 8, a computer as described in FIG. 7, a smartphone device, or any other display device. The fishing suggestion display 500 may be generated by a cloud software service.

In the illustrated display 500, a map is shown with fishing suggestions 520. The patterned areas 520, which in this illustration are patterned with dots, are areas where fishing is highly suggested. The areas without a pattern 510 are areas where fishing is not as highly suggested. For example, if the fishing criteria is that a user wants to catch fish in an afternoon during the fall in the area illustrated in display 500, areas 520 are areas where the user may be likely to catch fish during a fall afternoon, and areas 510 are areas where the user would be less likely to catch fish. Suggestions may be generated by method 400, described further in FIG. 4. Although the suggestions are displayed in the display 500 using patterns, any technique may be used to display the fishing suggestions. For example, numbers, colors or shading may be used to represent the fishing suggestions.

In one implementation, display 500 may illustrate aggregate sonar data or Fish IDs. For example, areas 520 may be areas with a higher concentration of Fish IDs or sonar activity, and areas 510 may be areas with a lower concentration of Fish IDs or sonar activity. In this implementation, the display 500 may be generated by methods 200 or 300.

FIG. 5B illustrates a fishing suggestion display 530 with selections in accordance with various implementations described herein. The fishing suggestion display 530 may be displayed on a marine electronics device as described in FIG. 8, a computer as described in FIG. 7, a smartphone device, or any other display device. The fishing suggestion display 530 may be generated by a cloud software service.

In the illustrated display 530, a map is shown with fishing suggestions 520. The criteria used to generate the suggestions 520 may be altered using slider 540 and selection box 550. Using the slider 540, a user may select a range of time for the suggestions in display 530. As the user alters the selection made using the slider 540, the displayed suggestions 520 may change in response to the selection. The selection box 550 may be used to select one or more species of fish that a user wants to catch. The suggestions 520 displayed on the map may change in response to the user's selections made using the selection box 550. Although time and species are shown as criteria that may be selected in the display 530, other criteria may be altered using a slider 540, selection box 550, or other input. For example, a user may be able to select a wind direction and speed by drawing an arrow on the map. In another example, the user may be able to select a location by selecting and dragging the map, or by zooming in or out.

In one implementation, the display 530 may illustrate aggregate sonar data or Fish IDs. The slider 540 and selection box 550 may be used to modify input criteria for the displayed aggregate sonar data. In this implementation, the display 530 may be generated by methods 200 or 300.

FIG. 6 is a diagram of fishing data sources in accordance with implementations of various techniques described herein. Data may be collected from various sources and stored as aggregated sonar data 600. These sources may include a Marine Electronics Device 610, External Information 620, and a Sonar Device 630. Aggregate sonar data 600 may be used to generate fishing suggestions or the sonar data may be displayed on a map or chart, as illustrated in FIGS. 5A and 5B. In one implementation, the aggregate sonar data 600 is stored on a database. Data from various sources may be transferred to a cloud software service, stored on the database, and used as aggregate sonar data 600. Aggregate sonar data 600 may be located on a computer system 700, or on any device capable of collecting and storing fishing data, including a marine electronics device 800 or a smart phone device. Aggregate sonar data 600 may include data collected by one or more fishermen. For example, aggregate sonar data 600 may include data collected by a plurality of users of a cloud software service.

A fishfinder, sounder, transducer, or any other sonar device 630 may be used to collect sonar data. The sonar data may include a plurality of Fish IDs, depth, vegetation data, bottom composition, or structure data. The sonar data collected using sonar device 630 may be transmitted to a marine electronics device 610, or directly to a database storing aggregate sonar data 600. The marine electronics device 610 is described in more detail with reference to FIG. 8.

The marine electronics device 610 may collect data such as water temperature, location, speed, speed over ground, speed over water, bearing, heading, sonar data, overhead conditions, wind speed and direction, atmospheric temperature, current, cast data, catch data, and other data. This information may be transmitted directly to a database, or may be transmitted to another device, such as a smart phone, and then transmitted to a database.

External information 620 may also be retrieved and stored as aggregate sonar data 600. The external information 620 may be retrieved from the Internet or any other source by a computer system 700. The external information 620 may include atmospheric temperature, tidal data, weather, moon phase, sunrise, sunset, water levels, or any other fishing data.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. As such, the computing systems may be configured to operate using sonar, radar, GPS and like technologies.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 7 illustrates a computer system 700 into which implementations of various technologies and techniques described herein may be implemented. Computing system 700 may be a conventional desktop, a handheld device, a wearable device, a controller, a personal digital assistant, a server computer, an electronic device/instrument, a laptop, a tablet, or part of a navigation system, marine electronics, or sonar system. It should be noted, however, that other computer system configurations may be used.

The computing system 700 may include a central processing unit (CPU) 730, a system memory 726 and a system bus 728 that couples various system components including the system memory 726 to the CPU 730. Although only one CPU 730 is illustrated in FIG. 7, it should be understood that in some implementations the computing system 700 may include more than one CPU 730.

The CPU 730 can include a microprocessor, a microcontroller, a processor, a programmable integrated circuit, or a combination thereof. The CPU 730 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 730 may also include a proprietary processor. The CPU may include a multi-core processor.

The CPU 730 may provide output data to a Graphics Processing Unit (GPU) 731. The GPU 731 may generate graphical user interfaces that present the output data. The GPU 731 may also provide objects, such as menus, in the graphical user interface. A user may provide inputs by interacting with the objects. The GPU 731 may receive the inputs from interaction with the objects and provide the inputs to the CPU 730. In one implementation, the CPU 730 may perform the tasks of the GPU 731. A video adapter 732 may be provided to convert graphical data into signals for a monitor 734. The monitor 734 includes a screen 705. The screen 705 can be sensitive to heat or touching (now collectively referred to as a “touch screen”). In one implementation, the computer system 700 may not include a monitor 734.

The GPU 731 may be a microprocessor specifically designed to manipulate and implement computer graphics. The CPU 730 may offload work to the GPU 731. The GPU 731 may have its own graphics memory, and/or may have access to a portion of the system memory 726. As with the CPU 730, the GPU 731 may include one or more processing units, and each processing unit may include one or more cores.

The system bus 728 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 726 may include a read only memory (ROM) 712 and a random access memory (RAM) 716. A basic input/output system (BIOS) 714, containing the basic routines that help transfer information between elements within the computing system 700, such as during start-up, may be stored in the ROM 712. The computing system may be implemented using a printed circuit board containing various components including processing units, data storage memory, and connectors.

Certain implementations may be configured to be connected to a GPS and/or a sonar system. The GPS and/or sonar system may be connected via the network interface 744 or Universal Serial Bus (USB) interface 742. In one implementation, the computing system 700, the monitor 734, the screen 705 and buttons may be integrated into a console.

The computing system 700 may further include a hard disk drive 736 for reading from and writing to a hard disk 750, a memory card reader 752 for reading from and writing to a removable memory card 756 and an optical disk drive 754 for reading from and writing to a removable optical disk 758, such as a CD ROM, DVD ROM or other optical media. The hard disk drive 750, the memory card reader 752 and the optical disk drive 754 may be connected to the system bus 728 by a hard disk drive interface 736, a memory card interface 738 and an optical drive interface 740, respectively. The drives and their associated computer-readable media may provide nonvolatile storage of computer-readable instructions, data structures, program modules and other data for the computing system 700.

Although the computing system 700 is described herein as having a hard disk 750, a removable memory card 756 and a removable optical disk 758, it should be appreciated by those skilled in the art that the computing system 700 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 700. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. The computing system 700 may also include a host adapter 733 that connects to a storage device 735 via a small computer system interface (SCSI) bus, a Fiber Channel bus, an eSATA bus, or using any other applicable computer bus interface. The computing system 700 can also be connected to a router 764 to establish a wide area network (WAN) 766 with one or more remote computers 774. The router 764 may be connected to the system bus 728 via a network interface 744. The remote computers 774 can also include hard disks 772 that store application programs 770.

In another implementation, the computing system 700 may also connect to one or more remote computers 774 via local area network (LAN) 776 or the WAN 766. When using a LAN networking environment, the computing system 700 may be connected to the LAN 776 through the network interface or adapter 744. The LAN 776 may be implemented via a wired connection or a wireless connection. The LAN 776 may be implemented using Wi-Fi technology, cellular technology, or any other implementation known to those skilled in the art. The network interface 744 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 774. It will be appreciated that the network connections shown are exemplary and other means of establishing a communications link between the computer systems may be used. The network interface 744 may also include digital cellular networks, Bluetooth, or any other wireless network interface.

A number of program modules may be stored on the hard disk 750, memory card 756, optical disk 758, ROM 712 or RAM 716, including an operating system 718, one or more application programs 720, program data 724 and a database system. The one or more application programs 720 may contain program instructions configured to perform methods 200, 300 or 400 according to various implementations described herein. The operating system 718 may be any suitable operating system that may control the operation of a networked personal or server computer, such as Windows® XP, Mac OS® X, Unix-variants (e.g., Linux® and BSD®), Android®, iOS®, and the like.

A user may enter commands and information into the computing system 700 through input devices such as a keyboard 762 and pointing device. Other input devices may include a microphone, joystick, game pad, satellite dish, scanner, user input button, wearable device, or the like. These and other input devices may be connected to the CPU 730 through a USB interface 742 coupled to system bus 728, but may be connected by other interfaces, such as a parallel port, Bluetooth or a game port. A monitor 705 or other type of display device may also be connected to system bus 728 via an interface, such as a video adapter 732. In addition to the monitor 734, the computing system 700 may further include other peripheral output devices such as speakers and printers.

### Marine Electronics Device

FIG. 8 illustrates a schematic diagram of a marine electronics device 800 in accordance with various implementations described herein. The marine electronics device 800 includes a screen 805. In certain implementations, the screen 805 may be sensitive to touching by a finger. In other implementations, the screen 805 may be sensitive to the body heat from the finger, a stylus, or responsive to a mouse. The marine electronics device 800 may be attached to a National Marine Electronics Association (NMEA) bus or network. The marine electronics device 800 may send or receive data to or from another device attached to the NMEA 2000 bus. For example, the marine electronics device 800 may transmits commands and receive data from a motor or a sensor using an NMEA 2000 bus. The marine electronics device 800 may transmit or receive NMEA 2000 compliant messages, messages in a proprietary format that do not interfere with NMEA 2000 compliant messages or devices, or messages in any other format. The device 800 may display marine electronic data 815. The marine electronic data types 815 may include chart data, radar data, sonar data, steering data, dashboard data, navigation data, fishing data, and the like. The marine electronics device 800 may also include a plurality of buttons 820, which may be either physical buttons or virtual buttons, or a combination thereof. The marine electronics device 800 may receive input through a screen 805 sensitive to touch or buttons 820. The marine electronics device 800 may be connected to a motion capture device using a wired connection, such as USB, or through a wireless connection, such as Bluetooth.

While the foregoing is directed to implementations of various techniques described herein, other and further implementations may be devised without departing from the basic scope thereof, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon a plurality of computer-executable instructions which, when executed by a computer, cause the computer to:
receive sonar data recorded by a sonar device on a marine vessel, wherein the sonar data is recorded during a plurality of fishing trips;
analyze the sonar data to detect sonar data corresponding to one or more fish;
receive locations corresponding to the fish; and
use the locations to display the detected fish on a map.

2. The non-transitory computer-readable medium of claim 1, wherein the locations are recorded by a Global Positioning System (GPS) device on the vessel.

3. The non-transitory computer-readable medium of claim 1, wherein a record of the detected fish and locations are transmitted to a cloud software service.

4. The non-transitory computer-readable medium of claim 1, wherein the computer-executable instructions further cause the computer to:
receive dates, times, environmental conditions, or combinations thereof corresponding to the sonar data; and
display the dates, times, environmental conditions, or combinations thereof on the map.

5. The non-transitory computer-readable medium of claim 1, wherein the computer-executable instructions that cause the computer to use the locations to display the detected fish on the map comprise computer-executable instructions that cause the computer to indicate locations with a sonar signal return greater than a predetermined sonar signal return level.

6. The non-transitory computer-readable medium of claim 1, wherein the computer-executable instructions further cause the computer to:
analyze the sonar data to detect one or more structures; and
display the structures on the map.

7. The non-transitory computer-readable medium of claim 1, wherein the computer-executable instructions further cause the computer to:
analyze the sonar data to estimate the size or depth of the detected fish based on sonar signal return strength; and
display the size or depth on the map.

8. The non-transitory computer-readable medium of claim 1, wherein the computer-executable instructions that cause the computer to use the locations to display the detected fish on the map comprise computer-executable instructions that cause the computer to display a concentration of detected fish on the map.

9. The non-transitory computer-readable medium of claim 1, wherein the computer-executable instructions that cause the computer to use the locations to display the detected fish on a map comprise computer-executable instructions that cause the computer to display the detected fish on the map using colors, patterns, or numbers.

10. The non-transitory computer-readable medium of claim 1, wherein the computer-executable instructions further cause the computer to remove false positives from the sonar data.

11. The non-transitory computer-readable medium of claim 10, wherein the computer-executable instructions that cause the computer to remove false positives comprise computer-executable instructions that cause the computer to compare the sonar data to stored sonar data recorded at a same location as the sonar data.

12. The non-transitory computer-readable medium of claim 10, wherein the computer-executable instructions that cause the computer to remove false positives comprise computer-executable instructions that cause the computer to compare the sonar data to stored sonar data recorded at a different location from the sonar data.

13. A non-transitory computer-readable medium having stored thereon a plurality of computer-executable instructions which, when executed by a computer, cause the computer to:
receive a location, a date, a time, environmental conditions, or combinations thereof;
retrieve sonar data recorded during a plurality of fishing trips corresponding to the location, date, time, environmental conditions, or combinations thereof; and
display the retrieved sonar data on a map.

14. The non-transitory computer-readable medium of claim 13, wherein the computer-executable instructions that cause the computer to display the retrieved sonar data on the map comprise computer-executable instructions that cause the computer to indicate areas with a sonar signal return greater than a set sonar signal return level.

15. The non-transitory computer-readable medium of claim 13, wherein the retrieved sonar data comprises individual records of detected fish.

16. A non-transitory computer-readable medium having stored thereon a plurality of computer-executable instructions which, when executed by a computer, cause the computer to:
receive a location, a date, a time, environmental conditions, or combinations thereof;
retrieve sonar data recorded using a sonar device on a marine vessel corresponding to the location, date, time, environmental conditions, or combinations thereof; and
analyze the retrieved sonar data to determine one or more suggested fishing locations.

17. The non-transitory computer-readable medium of claim 16, wherein the computer-executable instructions further cause the computer to display the suggested fishing locations on a map.

18. The non-transitory computer-readable medium of claim 16, wherein the sonar data comprise sonar data recorded during a plurality of fishing trips.

19. The non-transitory computer-readable medium of claim 16, wherein the retrieved sonar data comprises individual records of detected fish.

20. The non-transitory computer-readable medium of claim 16, wherein the computer-executable instructions that cause the computer to analyze the retrieved sonar data to determine one or more suggested fishing locations comprise computer-executable instructions that cause the computer to suggest fishing locations with a greater than average number of detected fish.
